(19) United States
(12) Patent Application Publication
(10) Pub. No.: US 2011/0019892 A1
(43) Pub. Date: Jan. 27, 2011

(54) METHOD AND APPARATUS FOR VISUALLY SUPPORTING AN ELECTROPHYSIOLOGICAL CATHETER APPLICATION

(76) Inventors: Norbert Rahn, Forchheim (DE); Dietrich Till, Forchheim (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/840,361

(22) Filed: Jul. 21, 2010

(30) Foreign Application Priority Data
Jul. 22, 2009 (DE) 10 2009 034 245.1

(51) Int. Cl. G06K 9/00

(52) U.S. Cl. 382/131; 348/E07.085

(57) ABSTRACT

A method for visually supporting an electrophysiological catheter application is provided. An electroanatomical 3D mapping data of a region of interest in the heart is visualized. A 3D image data of the region of interest is captured before the catheter application. A 3D surface profile of objects in the region of interest is extracted from the 3D image data by segmentation. The electroanatomical 3D mapping data and 3D image data forming at least the 3D surface profile is assigned by registration and visualized superimposed on one another. Characteristic parameters are measured for catheter guidance during the catheter application. The characteristic parameters are compared with at least one predefined threshold value and regulation data for catheter guidance is generated as a function of the comparison result. The regulation data is integrally displayed and represented in the superimposed visualization.

### CROSS REFERENCE TO RELATED APPLICATIONS

This application claims priority of German application No. 10 2009 034 245.1 filed Jul. 22, 2009, which is incorporated by reference herein in its entirety.

### FIELD OF THE INVENTION

The invention relates to a method and an apparatus for visually supporting an electrophysiological catheter application as claimed in the respective preambles of the independent claims.

### BACKGROUND OF THE INVENTIION

The treatment of cardiac arrhythmia has changed significantly since the introduction of the technique of catheter ablation by means of high-frequency current. In this technique an ablation catheter is introduced under x-ray monitoring into one of the heart chambers, via veins or arteries, and obliterates the tissue causing the cardiac arrhythmia by means of high-frequency current. Ablation procedures, for example in the left atrium, to treat atrial fibrillation, are carried out on the basis of electrophysiological and anatomical criteria. This produces three-dimensional morphological information from imaging modalities such as CT, MR or 3D-x-ray rotation angiography, as known for example from DE 10 2005 016 472 A1.

For catheter ablation to be completed successfully, it is necessary for the cause of the cardiac arrhythmia to be precisely localized in the heart chamber. This localization is generally effected by means of an electrophysiological investigation, in which electrical potentials are captured with spatial resolution by means of a mapping catheter introduced into the heart chamber. This electrophysiological investigation, known as electroanatomical mapping, thus produces 3D mapping data that can be visualized on a monitor. The mapping function and the ablation function are therefore often combined in a single catheter, so that the mapping catheter is also simultaneously an ablation catheter.

The following electroanatomical tracking or 3D mapping methods are possible:

The Carto system by the company Biosense Webster Inc., USA can import three-dimensional morphological image data, segment it and superimpose it with the electroanatomical mapping data. In this process pairs of anatomical landmarks are generally used, being identified in both the mapping and the 3D image data and then being used for superimposition. The surface of the Carto model can also be superimposed with the 3D image data by means of surface registration, as known for example from DE 103 40 544 B4.

The NavX-System by St. Jude Medical can import three-dimensional morphological image data, segment it and superimpose it with the electroanatomical mapping data. In this process pairs of anatomical landmarks are used, being identified both in the mapping and the 3D image data and then being used for superimposition. A more refined registration method than the one set out above is possible here.

The TactiCath catheter (Endosense, Meyrin, Switzerland) can be used as the catheter for measuring the contact pressure on the endocardium of the heart chamber to be ablated and for making this measurement data available as external information.

The aim here is to carry out the therapy as effectively as possible using the three-dimensional morphology.

The effectiveness of an ablation lesion (e.g. transmurality) at each ablation point is a function of
the local anatomical characteristics of the target tissue (tissue thickness, risk factor of target region)
local contact pressure (contact force) of the ablation catheter on the myocardium
emitted energy (output) of the ablator
ablation time (local stay time) at an ablation point

These parameters are currently varied intuitively by manual parameterization of the ablator (e.g. setting of maximum values) and by catheter guidance, without taking into consideration the dependencies of the parameters (contact pressure, stay time, anatomy). The parameters vary considerably from user to user. The same applies to the anatomy of the patient.

The result is ablation lesions of varying effectiveness (e.g. incomplete rather than—as desired—complete ablation lines), which may not result in the desired successful therapy and may require the entire procedure to be repeated at a later time.

### SUMMARY OF THE INVENTION

The object of the present invention is to specify a method and an apparatus for controlling or monitoring a catheter ablation, allowing better planning of the guidance of the catheter and better catheter application.

The object is achieved with the method and apparatus as claimed in the independent claims. Advantageous embodiments of the method and apparatus are set out in the dependent claims or will emerge from the description which follows and the exemplary embodiments.

One aspect of the invention is an automatic ablation control, which produces the optimum lesion by regulating the emission of ablation energy taking into account the characteristic parameters
contact pressure of the ablation catheter
stay time (ablation time at an ablation point)
individual morphological characteristics of the target region.

The invention describes an ablation regulation that produces the optimum lesion by regulating the emission of ablation energy taking into account the parameters
contact pressure of the ablation catheter
ablation time at an ablation point
morphological characteristics at the current ablation point.

This allows an ablation lesion to be planned more efficiently. This results in effective ablation lesions which increase the ablation success rate and reduce the re-ablation rate.

Patient safety is also influenced positively, as on the one hand careful attention is paid to the anatomical risk areas during the therapy and on the other hand the increased efficiency of the intervention means that repetitions of the procedure are avoided.

### BRIEF DESCRIPTION OF THE DRAWINGS

Further advantages, details and developments of the invention will emerge from the description which follows of exemplary embodiments in conjunction with the drawings, in which:

FIG. 1 shows an example of an imaging apparatus, preferably an x-ray diagnosis facility for implementing the inventive method and

FIG. 2 shows an exemplary diagram of the principles of the invention.

### DETAILED DESCRIPTION OF THE INVENTION

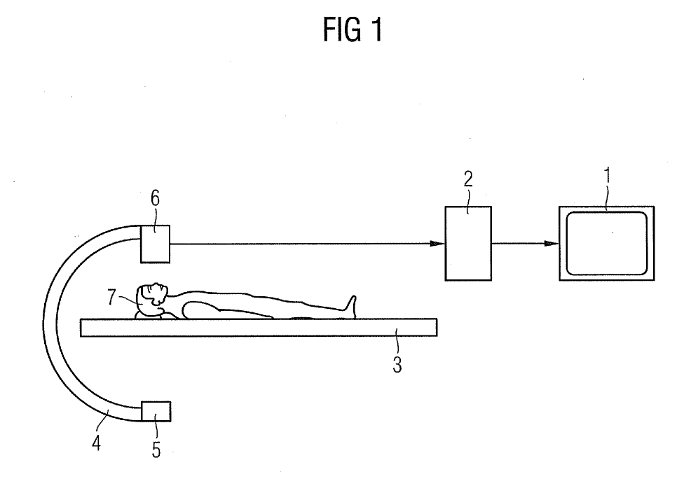

By way of example FIG. 1 shows an x-ray diagnosis facility having a C-arm 4 that is supported in a rotatable manner on a stand (not shown), at the ends of which C-arm 4 are disposed an x-ray radiation source 6, for example an x-ray emitter, and an x-ray image detector 5.

The x-ray image detector 5 can be a rectangular or square, flat semiconductor detector, which is preferably made of amorphous silicon (aSi).

In the beam path of the x-ray radiation source 6 is a patient support couch 3 for holding a region of a patient 7 to be examined. An image system 2 is connected to the x-ray diagnosis facility to receive and process the image signals of the x-ray image detector 5. The processed image signals can then be displayed on a display apparatus 1 connected to the image system 2.

The x-ray radiation source 6 emits a beam bundle from a beam focal point of the x-ray radiation source 6, said beam striking the x-ray image detector 5.

The x-ray radiation source 6 and the x-ray image detector 5 rotate respectively around the region to be examined, so that the x-ray radiation source 6 and the x-ray image detector 5 are located opposite one another on opposing sides of the region.

To create 3D data records the C-arm 4 that is supported in a rotatable manner with the x-ray emitter and the x-ray detector 5 is rotated in such a manner that the x-ray radiation source 6 moves on a rotation path and the x-ray image detector 5 moves on a rotation path around a region to be examined or of interest (e.g. heart) of the patient 7. The rotation paths can be traveled completely or partially to create a 3D data record.

Within the context of the invention the tomographic imaging apparatus can be for example x-ray C-arm systems, x-ray biplanar devices, computed tomographs, MR or PET. The C-arm 4 can also be replaced by what is known as en electronic C-arm, with which there is electronic coupling of the x-ray emitter and the x-ray detector 5. The C-arm can also be guided on robot arms, which are attached to the ceiling or floor. The method can also be implemented with x-ray devices, with which the individual image-generating components 5 and 6 are held respectively by a robot arm, such robot arms being disposed on the ceiling and/or floor.

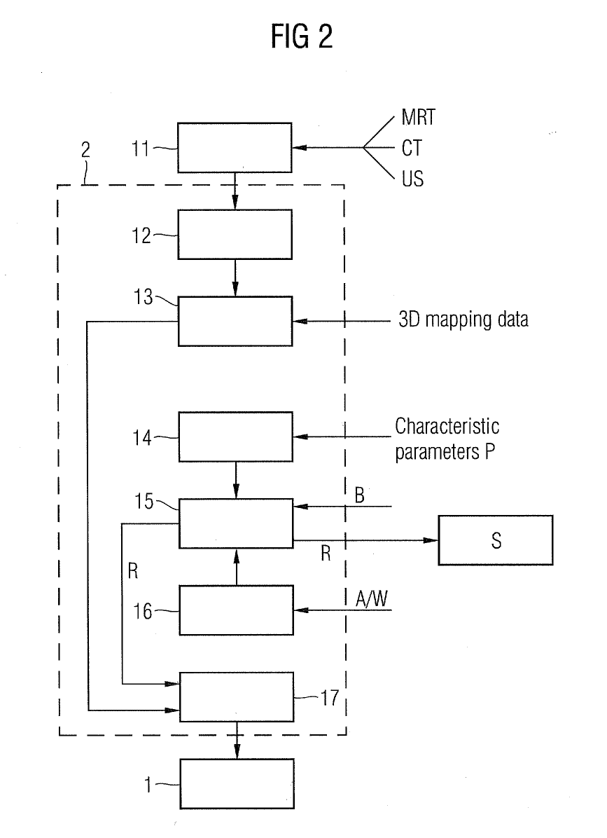

To this end FIG. 2 shows the individual steps during the implementation of the inventive method and/or the individual modules of the associated apparatus.

In a first step with the present method the 3D image data of the region to be treated, in particular of the heart chamber to be treated, is captured. When this 3D image data is captured, it is possible also to include a larger part of the heart for the registration to be carried out later. The 3D image data is captured using a 3D imaging method, such as for example x-ray computed tomography, magnetic resonance tomography or 3D ultrasound techniques.

During the implementation of the method it is favorable for high-resolution image data of the heart chamber to be captured.

In the second step the 3D image data is segmented to extract the 3D surface profile of vessels and heart chambers contained therein. Such segmentation is expedient on the one hand for the subsequent representation of the surface profile of such objects in the superimposed image representation and on the other hand in one advantageous embodiment of the method for assignment to the 3D mapping data.

Segmentation takes place in the segmentation module 11. This segmentation module 11 receives the captured 3D image data by way of a corresponding input interface 11. The 3D mapping data is supplied to the apparatus 2 in a similar manner by way of the same or a further interface 13.

For registration by surface matching it is however not necessary to segment the entire surface for example of the heart chamber to be treated. Instead it is sufficient for this purpose to obtain a representation of the surface of a region of interest in the chamber, for example the left atrium, or of regions of interest in the heart vessels, for example the pulmonary veins, by means of a few surface points, with which surface matching can be carried out for the registration. On the other hand it can however be advantageous to include a larger region, in particular further heart chambers or vessels, for the registration.

The 3D surface profile of the objects obtained from the segmentation is supplied to the registration module 12, in which the 3D image data or the data of the 3D surface profile obtained therefrom is assigned to the 3D mapping data provided. It is possible to obtain the 3D mapping data by way of a mapping catheter, which supplies 3D coordinates of surface points on the heart chamber to be treated by way of a 6D position sensor integrated in the tip of the catheter.

During the catheter ablation or the electroanatomical measuring of the heart chamber to be treated, increasingly more surface points are added to the mapping data in the course of time. These surface points are used for reconstructing the morphological structure of the chamber, i.e. for visualizing it. In this manner an increasingly more detailed image of the heart chamber to be treated is produced from the electro-anatomical 3D mapping data in the course of time.

In this context it is also possible to capture and reconstruct predominantly complete anatomical surfaces of other heart chambers and vessels electroanatomically before carrying out the catheter ablation. This electroanatomical 3D mapping data is then provided before the catheter ablation is carried out and can contribute to the later registration.

During registration in the registration module 13, in addition to assignment, matching of the dimensions of the 3D image data and the 3D mapping data also takes place. This is favorable in order to achieve the most accurate superimposition possible of the 3D image data of the heart chamber or its surface in identical position, orientation, scaling and form with the corresponding visualization of the heart chamber from the 3D mapping data.

After registration between the 3D mapping data and the 3D image data superimposition is carried out for visualization of the superimposed data in the visualization module 17. The superimposed visualization can take place at a display apparatus 1 for example.

In the next step measured parameters P characteristic of catheter guidance are received in a communication module 14. The characteristic parameters P preferably include catheter contact pressure, ablation energy and ablation time as values.

Provided there is an anatomical 3D model—as described above, also referred to as an atlas model—of the region of interest, e.g. heart chamber in the left atrium, threshold values, which can optionally be changed by a user, are stored at all points in the atlas-based model (e.g. 0 for risk regions, e.g. pulmonary veins, esophagus, mitral valve, e.g. 1 at planned lesions or thicker myocardium wall regions).

In a regulation module 15 the characteristic parameter values P are compared with at least the predefined threshold value and regulation data R for catheter guidance is generated as a function of the comparison result and one or more output interfaces, outputting the regulation data to at least one control point S controlling the catheter guidance. The regulation data R is provided by way of a possible further output interface for a representation that is preferably visualized at a display apparatus 1 or an acoustic representation.

The regulation module 15 is preferably a graphical user interface B, by way of which an operator can manually establish a threshold value for the characteristic parameters.

Different representation techniques are possible for visualization purposes. Bars for example can be used for display purposes, their length indicating the amplitude of the parameters. The bars can also be color coded (e.g. based on the defaults stored in the atlas model relating to the minimum/maximum of the three parameters). Thus for example each of the three bars can be green, if the parameter lies within the defined interval at the ablation site and can change to red, as soon as it is out of the interval. The combination or weighted sum of the three parameters can also be indicated by way of a fourth bar.

The ablation energy can be color-coded or can be shown simply as a numerical output of the energy or alternatively or additionally by way of an acoustic output of a tone, the volume and/or level of which represents the amplitude of the energy emitted.

The threshold values and ablation sites can also be color-coded (e.g. green: effective ablation should take place here, red: a risk region where ablation must not take place).
The threshold values may also be much higher in the direct area around planned ablation lesions than in the case of regions further away from the planned lesions.
The following are stored with the threshold values for each possible site:
   Minimum/maximum of catheter contact pressure (perpendicular angle assumed between catheter and endocardium); the tangential forces of the catheter contact pressure can optionally also be used.
   Minimum/maximum of the ablation energy
   Minimum/maximum of the ablation time
   (for example weighted) sum of the three last-mentioned parameters.

It is also possible for a calculation module 16 to be provided, which calculates an instantaneous distance A between a catheter tip and a predefinable pixel of the 3D image data and stores its result in the regulation data.

It is also possible for an instantaneous angle W between a catheter tip and a predefinable pixel of the 3D image data to be calculated in the calculation module 16 and its result to be stored in the regulation data.

Optionally usable: the energy emission of the ablator is regulated as a function of the current distance A between the ablation catheter tip and the preplanned lesion (which is stored—as described above—in the 3D atlas model). The maximum energy (taking into account the parameters contact pressure, energy and stay time) is thus only emitted in direct proximity to the planned lesion (therapy region) and reduced to a minimum value with increasing distance from the planned lesion. The relationship between “distance from planned lesion” and “reduction of energy emission” can thus be configured by way of a—not necessarily linear—lookup table.

With regard to the parameter “contact pressure of ablation catheter” the two spatial angles W of the catheter tip relative to the endocardium wall are also taken into account (the angles are determined by means of pressure sensors at the catheter tip and on the catheter side). Thus where the angle is more perpendicular a greater wall contact is assumed than where the angle is flatter. More perpendicular angles therefore result in an increase in the parameter, while flatter angles result in a reduction of the parameter.

If an active navigation system is used for ablation purposes, as well as or as an alternative to varying the energy emission it is also possible to change (e.g. reduce) the contact pressure of the ablation catheter automatically.

1.-12. (canceled)

13. A method for supporting an electrophysiological catheter application on a patient, comprising:
displaying an electroanatomical 3D mapping data of a region of interest in a heart of the patient;
capturing a 3D image data of the region of interest before the catheter application;
segmenting the 3D image data for extracting a 3D surface profile data of an object in the region of interest;
registering the electroanatomical 3D mapping data with the 3D surface profile data;
superimposing the electroanatomical 3D mapping data with the 3D surface profile data;
measuring a characteristic parameter for catheter guidance during the catheter application;
comparing the characteristic parameter with a predefined threshold value;
generating a regulation data for catheter guidance based on the comparison; and
representing the regulation data in the superimposed electroanatomical 3D mapping data and the 3D surface profile data.

14. The method as claimed in claim 13, wherein the regulation data is represented in color.

15. The method as claimed in claim 13, wherein the characteristic parameter comprises values of catheter contact pressure, ablation energy, and ablation time.

16. The method as claimed in claim 15 wherein a weighted sum is calculated from the values of catheter contact pressure, ablation energy, and ablation time and is compared with the threshold value.

17. The method as claimed in claim 13, wherein the threshold value comprises an interval of a maximum value and a minimum value.

18. The method as claimed in claim 13, wherein the 3D image data is captured by an x-ray computed tomography, a magnetic resonance tomography, or a 3D ultrasound.

19. The method as claimed in claim 13, wherein an instantaneous distance between a catheter tip and a predefinable pixel of the 3D image data and/or the 3D mapping data is calculated and is stored in the regulation data.

20. The method as claimed in claim 13, wherein an instantaneous angle between a catheter tip and a predefinable pixel of the 3D image data and/or the 3D mapping data is calculated and is stored in the regulation data.

21. An apparatus for supporting an electrophysiological catheter application on a patient, comprising:
a 3D image device that captures a 3D image data of a region of interest in a heart of the patient before the catheter application;
an input interface that receives the 3D image data and an electroanatomical 3D mapping data of the region of interest;
a segmentation module that segments the 3D image data for extracting a 3D surface profile data of an object in the region of interest;
a registration module that registers the electroanatomical 3D mapping data with the 3D surface profile data;
a visualization module that superimposes the electroanatomical 3D mapping data with the 3D surface profile data;
a communication module that receives a characteristic parameter for catheter guidance during the catheter application;
a regulation module that compares the characteristic parameter with a predefined threshold value and generates a regulation data for the catheter guidance based on the comparison;
an output interface that outputs the regulation data for controlling the catheter guidance; and
a display device that represents the regulation data by visualization or by an acoustic tone.

22. The apparatus as claimed in claim 21, wherein the regulation module comprises a graphical user interface for an operator to manually select the threshold value.

23. The apparatus as claimed in claim 21, further comprising a calculation module that calculates an instantaneous distance between a catheter tip and a predefinable pixel of the 3D image data and/or the 3D mapping data and stores the instantaneous distance in the regulation data.

24. The apparatus as claimed in claim 21, further comprising a calculation module that calculates an instantaneous angle between a catheter tip and a predefinable pixel of the 3D image data and/or the 3D mapping data and stores the instantaneous angle in the regulation data.
